(19) United States
(12) Patent Application Publication
(10) Pub. No.: US 2006/0174420 A1
(43) Pub. Date: Aug. 10, 2006

(54) Method of treating fabrics and fibres

(76) Inventors: Yi Li, Hong Kong SAR (CN); Jun-yan Hu, Hong Kong SAR (CN); Yin-fa Cheng, Hong Kong SAR (CN); K.W. Yeung, Hong Kong SAR (CN); Chun-wah Marcus Yuen, Hong Kong SAR (CN)

Correspondence Address: ALIX YALE & RISTAS LLP, 750 MAIN STREET, SUITE 1400, HARTFORD, CT, 06103, US

(21) Appl. No.: 11/053,291

(22) Filed: Feb. 8, 2005

(51) Int. Cl. C11D 3/00

(52) U.S. Cl. 8/115.51

(57) ABSTRACT

A solution for treating fabrics or fibres consists of between 0.1 and 10 percent natural fibre material suspended in distilled water. The solution is used to wet fabrics or fibres for a period of between 1 and 60 minutes. After wetting the fabrics or fibres are dried at a temperature of between 80 and 160 degrees Celsius for between 1 and 10 minutes.

### BACKGROUND OF THE INVENTION

1. Field of the Invention

The invention relates to methods of treating fabrics and fibres and in particular pure cotton and polyester fibres.

2. Description of Prior Art

Natural fibres have played an important role in the textile industry. They are widely used in the high quality garments because of their excellent intrinsic properties. However, a lot of natural fibres are short and cannot be spun into yarn for fabrication and producing garments. Additionally, many used garments made from natural fibres are discarded each year. How to use such recourses has large market potential because natural fibres have excellent intrinsic properties and are environmentally friendly. A lot of research has been done to find a use for natural fibre powder material. Hitherto they have been used to make cosmetic preparations and for making thermoplastic film, but there is no use for them in the textile industry.

### SUMMARY OF THE INVENTION

It is an object of the present invention to provide a use for short or discarded natural fibres and natural fibre powder material within the textile industry in a method of treating fabrics and fibres and in particular pure cotton and polyester fibres.

According to a first aspect of the invention there is a method of treating fabrics and fibres comprising preparing a solution comprising between 0.1 and 10 percent natural fibre material having an average particle size of less than 500 nano-meters, wetting fabric or fibres to be treated with the solution for a period of between 1 and 60 minutes, and drying the wetted fibres at a temperature of between 80 and 160 degrees Celsius for a period of between 1 and 10 minutes.

Preferably, the wetted fabric or fibres are further treated by padding with the solution before the drying step.

Preferably, the fabric or fibres are padded with the solution five times.

Preferably, the solution comprises 15 percent natural fibre material.

Preferably, the natural fibre material has an average particle size of less than 300 nano-meters.

Preferably, the fabric or fibres are wetted with the solution for not less than 15 minutes.

Preferably, the wetted fabric or fibres are dried at a temperature of 130 degrees Celsius for not less than five minutes.

Preferably, the fabric or fibres to be treated are selected from a group comprising cotton and polyester fabrics and fibres.

Preferably, the natural fibre material is a fine wool powder.

Further aspects of the invention will become apparent from the following drawings and description.

### BRIEF DESCRIPTION OF THE DRAWINGS

Embodiments of the invention will now be described by way of example only and with reference to the accompanying drawings which illustrate characteristic of treated fabrics.

### DESCRIPTION OF THE PREFERRED EMBODIMENTS

A method of treating fabrics and fibres, such as pure cotton and polyester fabrics and fibres, according to the invention comprises preparing a solution of nano scale natural fibre particles, wetting the fabrics or fibres to be treated with the solution and drying the wetted fabrics or fibres in an oven. In the preferred embodiment the natural fibre particles are a super fine natural wool powder.

Nature wool fibres have a diameter of between 15 and 30 micro meters. These fibres must be pulverised or crushed to nano size super fine natural wool powder for the preparation of the solution. A method of popularising natural fibre into nano-scale particles as described in applicants earlier PCT application published as WO 2004/055250 on 11 Jul. 2004. An alternative method of obtaining nano-scale particles from natural fibre is to use an apparatus for producing fine powder from organic material as described an applicant earlier U.S. patent application Ser. No. 10/354,170. The entire contents of WO 2004/055250 and Ser. No. 10/354,170 are incorporated herein by reference.

The average particle size of the nano scale natural wool fibre particulate should be less than 500 nano meters, and in preferably less than 300 nano meters. The particulate matter obtained from the pulverising or crushing techniques described in WO 2004/055250 and Ser. No. 10/354,170 may contain larger particles. These larger particles can be removed using a high-speed centrifuge or filtering.

If a centrifuge is used it should be run at a speed of 1500 to 8000-rpm (preferably 5000-rpm) for 5-15 minutes (preferably 10 minutes). The centrifuge separates the particular matter into upper and lower layers. The upper layer is used for preparation of the solution. The lower layer is returned to the pulverising or crushing process described in WO 2004/055250 and Ser. No. 10/354,170.

If a filter is used it should have a pore size less than 300 nano meters to remove the large particles.

The solution is prepared by suspending the super fine natural wool powder in distilled water. The ratio of wool powder to water is in the range 3 to 30 grams per litre. No other agents are required in the solution.

The fabric or fibres to be treated are wetted with the solution for 30 minutes. They are then padded with the solution five times.

After the fabric or fibres have been wetted they are dried and cured and in an oven at 130 degrees Celsius for five minutes.

The treated fibres have improved thermal, air permeability, ultraviolet blocking, liquid transfer, wrinkle recovery and blending properties.

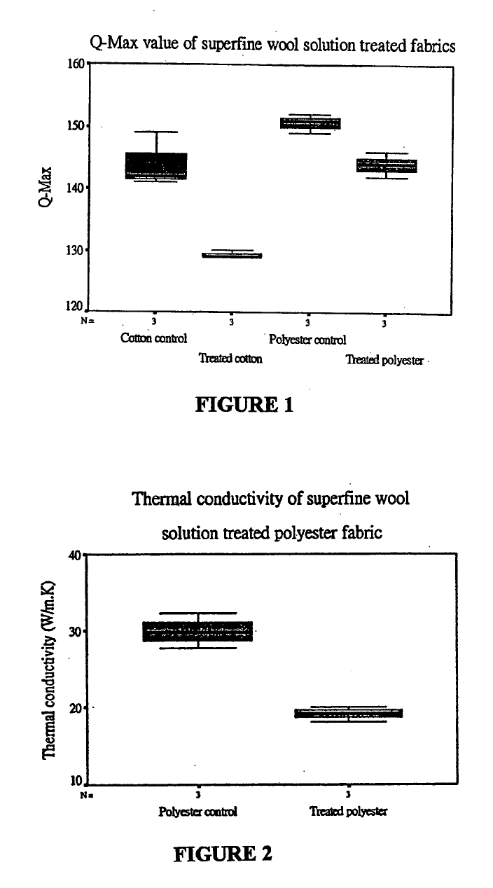

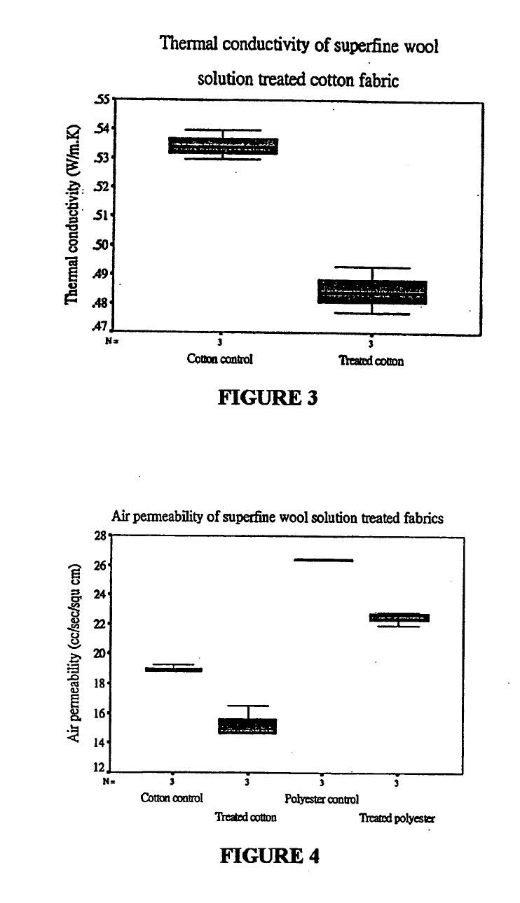

The thermal properties of the treated fabrics were evaluated using a KES-F7 Thermal Labo II (Precise and Prompt Thermal Prosperity Measurement Instrument), which can evaluate not only the warm/cool feeling (q-max value), but also thermal conductivity and insulation value (keep warm ratio). The change in thermal properties of treated fabrics is shown in the FIGS. 1-3. FIG. 1 shows that after treatment with the natural fibre solution, the q-max values of the treated cotton and polyester samples are much lower than that of the control fabrics. FIGS. 2 and 3 show that after treatment thermal conductivity of the cotton and polyester fabrics decreased.

The air permeability of the samples was tested by means of an ASTM D737-1996 using Shirley Development Limited Air Permeability Tester. FIG. 4 shows that superfine wool solution treated polyester and cotton fabrics have lower air permeability than that of the untreated control fabrics, which means that the treated fabrics have higher wind resistance.

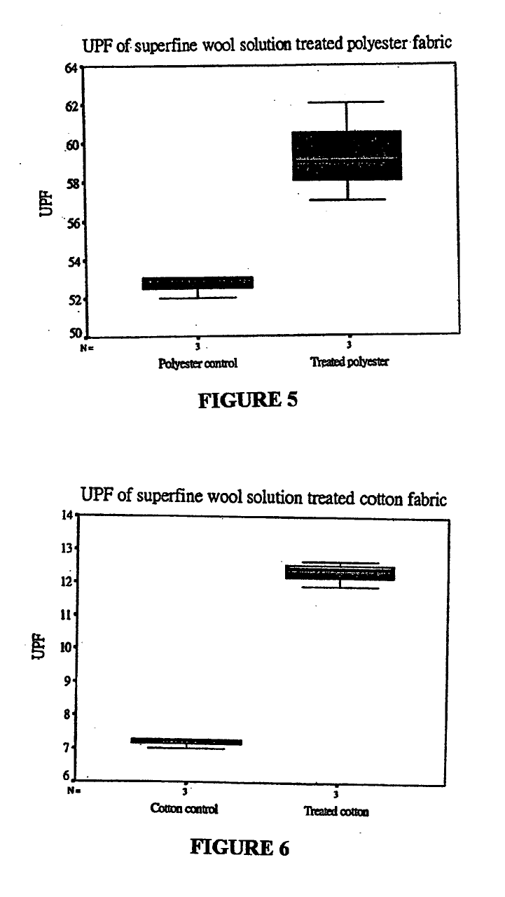

The ultraviolet protection factor (UPF) of treated fabric was tested on a Cary 300 Conc UV-Visible Spectrophotometer, according to Australian/New Zealand Standard AS/NZS 4399:1996. The results are summarized in FIGS. 5 and 6. The UPF value of both treated cotton and polyester fabric are significantly increased compared with the control samples.

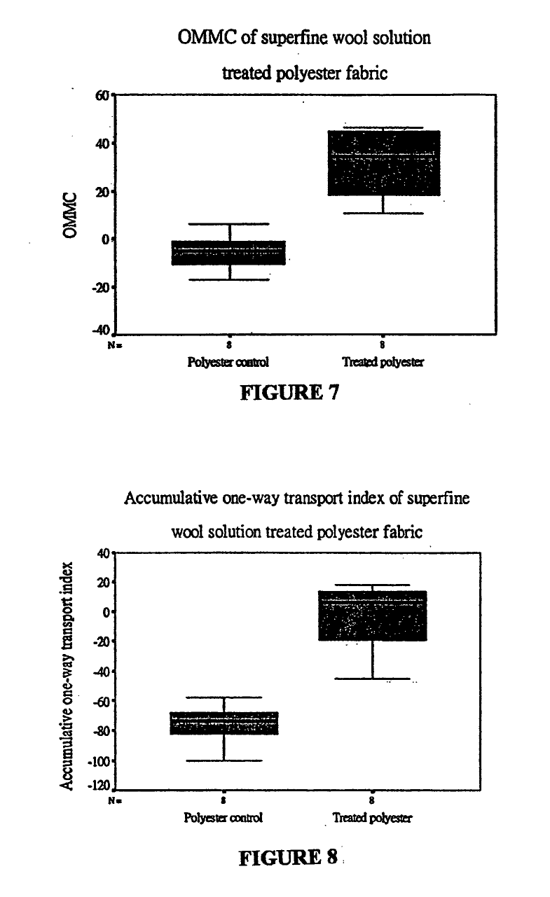

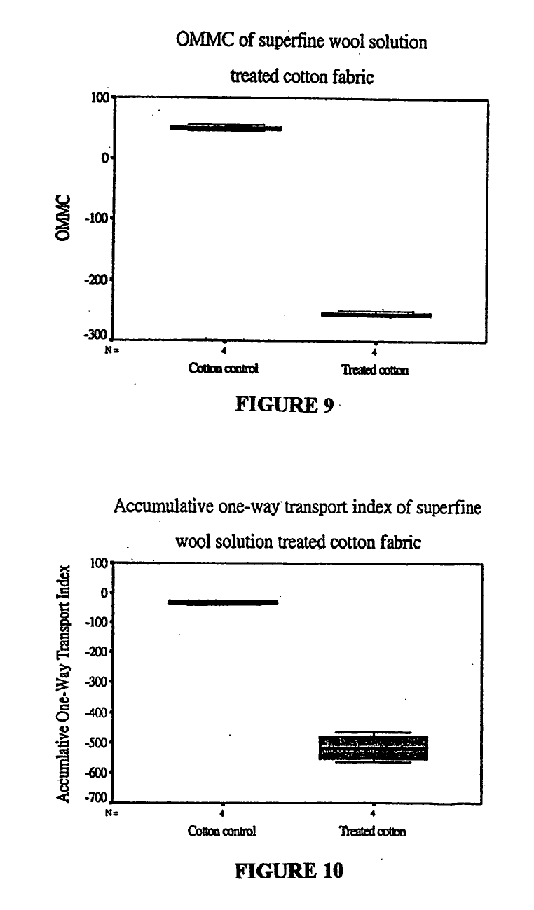

The liquid water transfer properties on the treated fabric were also changed. FIGS. 7 and 8 show that the original polyester fabric is hydrophobic fabric and liquid does not transfer through it well. After treatment, polyester fabrics had higher one-way transport capacity (OWTC) and overall moisture management capacity (OMMC) than that of the untreated control fabric, showing that liquid can be more easily transfer from the side next to skin to the opposite side. FIGS. 9 and 10 show that treated cotton fabrics have lower OWTC and OMMC than that of the untreated control fabric.

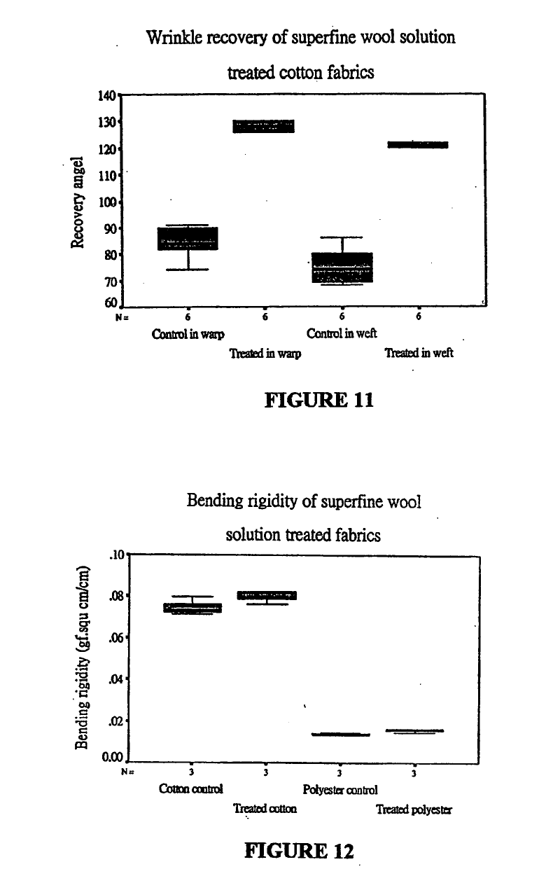

The wrinkle recovery of treated cotton fabric was determined according to the AATCC Test Method 66-1998 Wrinkle Recovery of Woven Fabrics. FIG. 11 shows that superfine wool treated fabric has greater recovery angle than that of the untreated control angle for both of the warp and weft direction of the fabrics.

The bending property is important for evaluating fabrics and is one of the components of a hand evaluation system. The bending rigidity of the treated cotton and polyester fabrics is tested by Kato Tech Co., Ltd, Pure Bending Tester KES-FB-2. The result of the testing is shown in FIG. 12. Treatment did not have much affect on the bending rigidity of the fabrics. This means the treatment does not change the bending rigidity of the fabric.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claimed is:

1. A method of treating fabrics and fibres comprising:
preparing a solution comprising between 0.1 and 10 percent natural fibre material having an average particle size of less than 500 nano-meters,
wetting fibres to be treated with the solution for a period of between 1 and 60 minutes, and
drying the wetted fibres at a temperature of between 80 and 160 degrees Celsius for a period of between 1 and 10 minutes.

2. The method of claim 1 wherein the wetted fabric or fibres are further treated by padding with the solution before the drying step.

3. The method of claim 2 wherein the fabric or fibres are padded with the solution five times.

4. The method of claim 1 wherein the solution comprises 15 percent natural fibre material.

5. The method of claim 1 wherein the natural fibre material has an average particle size of less than 300 nano-meters.

6. The method of claim 1 wherein the fabric or fibres are wetted with the solution for not less than 15 minutes.

7. The method of claim 1 wherein the wetted fabric or fibres are dried at a temperature of 130 degrees Celsius for not less than five minutes.

8. The method of claim 1 wherein the fabric or fibres to be treated are selected from a group comprising cotton and polyester fabrics and fibres.

9. A method of treating fabrics and fibres using fine wool powder comprising:
preparing a solution comprising between 0.1 and 10 percent fine wool powder having an average particle size of less than 300 nano-meters in distilled water,
wetting fibres to be treated with the solution for a period of between 1 and 60 minutes, and
drying the wetted fibres at a temperature of between 80 and 160 degrees Celsius for a period of between 1 and 10 minutes.

10. A method of treating pure cotton or polyester fabrics comprising:
preparing a solution comprising between 5 and 10 percent natural fibre material having an average particle size of less than 300 nano-meters,
wetting a cotton or polyester fabrics to be treated with the solution for a period of not less than 15 minutes minutes, and
drying the wetted fabric at a temperature of between 100 and 140 degrees Celsius for a period of not less than five minutes.
